(19) United States
(12) Patent Application Publication
(10) Pub. No.: US 2019/0072823 A1
(43) Pub. Date: Mar. 7, 2019

(54) ULTRAVIOLET CURING APPARATUS AND BEARING PLATFORM

(71) Applicants: HKC CORPORATION LIMITED, Shenzhen City (CN); CHONGQING HKC OPTOELECTRONICS TECHNOLOGY CO., LTD., JIESHI, BANAN DISTRICT (CN)

(72) Inventor: Chung-kuang CHIEN, Jieshi, Banan District (CN)

(73) Assignees: HKC CORPORATION LIMITED, Shenzhen City (CN); CHONGQING HKC OPTOELECTRONICS TECHNOLOGY CO., LTD., JIESHI, BANAN DISTRICT (CN)

(21) Appl. No.: 15/745,320

(22) PCT Filed: Aug. 31, 2017
(86) PCT No.: PCT/CN2017/100035

§ 371 Date: Jan. 16, 2018

(30) Foreign Application Priority Data
Dec. 26, 2016 (CN) 201611218962.X

(51) Int. Cl. G02F 1/1337; G02F 1/13; G02F 1/1333

(52) U.S. Cl. CPC G02F 1/133788; G02F 2001/133354; G02F 1/133305; G02F 1/1303

(57) ABSTRACT

Provided are an ultraviolet curing apparatus and support platform. The ultraviolet curing apparatus includes an ultraviolet irradiation apparatus and the support platform. The ultraviolet irradiation apparatus is configured to irradiate the flexible liquid crystal display (LCD) panel which is to form a flexible LCD panel with ultraviolet rays; the support platform is configured to support the flexible LCD panel; a surface of the support platform used for supporting the flexible LCD panel is a curved surface, and a shape of the curved surface is same with the shape of the LCD panel of which the manufacture process is completed.

### TECHNICAL FIELD

The present disclosure relates to an ultraviolet curing apparatus and a support platform.

### BACKGROUND

Since the curved screen makes it possible to keep the same distance between eyes and each point on the screen, such that a broader view and a stronger scene feel are provided. Based on above features, the application of the curved screen in the liquid crystal display (LCD) television (TV) may achieve the similar audience experience of image maximum (IMAX) in the living room. Therefore, the curved LCD TV becomes one of the research hot spots.

In the manufacture process of LCD panel, the ultraviolet curing process (UVM) plays a crucial role in the process of liquid crystal (LC) alignment. The basic principle of the UVM is that, after the LCD panel is conveyed to the UVM platform, the LCD panel exposes under ultraviolet, the process of the LC alignment is completed. Therefore, for the curved LCD panel, how to design a UVM applicable to the manufacture of the curved LCD panel remains as an unsettled problem.

### SUMMARY

The present disclosure relates to an ultraviolet curing apparatus and a support platform.

An ultraviolet curing apparatus includes:

a support platform, which is configured to support a flexible LCD panel; and

an ultraviolet irradiation apparatus, which is configured to irradiate the flexible LCD panel with ultraviolet rays, among which a surface of the support platform used for supporting the flexible LCD panel is a curved surface.

A support platform, which is applied in the ultraviolet curing apparatus, is configured to support the flexible LCD panel, among which the surface of the support platform which is used to support the flexible LCD panel is a curved surface.

An ultraviolet curing apparatus includes: a support platform having an adjustable surface which is used to support the flexible LCD panel; and a light source configured to irradiate the flexible LCD panel supported by the supporting surface of the support platform.

The baring platform includes a plurality of supporting rods which are vertically disposed, the plurality of supporting rods are vertically movable, the adjustable supporting surface is formed by top of the plurality of supporting rods.

### BRIEF DESCRIPTION OF DRAWINGS

FIG. 1 is a structure diagram of an ultraviolet curing apparatus provided by an embodiment of the present disclosure;

FIG. 2 is a diagram illustrating the operating process for the ultraviolet exposure of LCD panel by using the ultraviolet curing platform in FIG. 1;

FIG. 3 is a structure diagram of an ultraviolet curing apparatus with a support platform provided by another embodiment of the present disclosure;

FIG. 4 is a diagram illustrating the operating process for the ultraviolet exposure of LCD panel by using the ultraviolet curing platform in FIG. 3.

### DETAILED DESCRIPTION

Except alternative definition, all of the technologies and scientific terminologies used in the present disclosure are in accordance with the meanings understood by those skilled in the art. The terminologies used in the descriptions of the present disclosure are intended to describe the specific embodiment and not to limit the present disclosure. The term “and/or” used in the present disclosure includes an arbitrary combination or all combinations of one or more listed items.

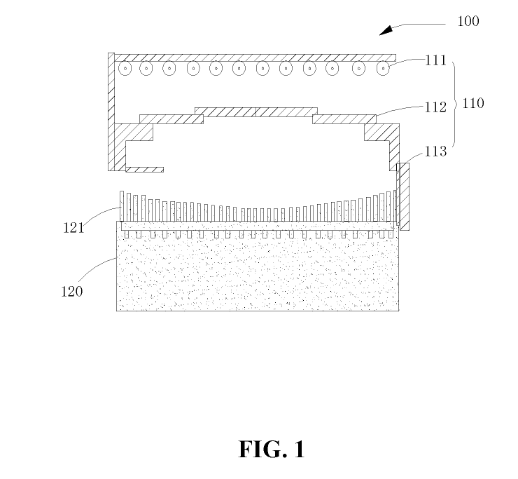

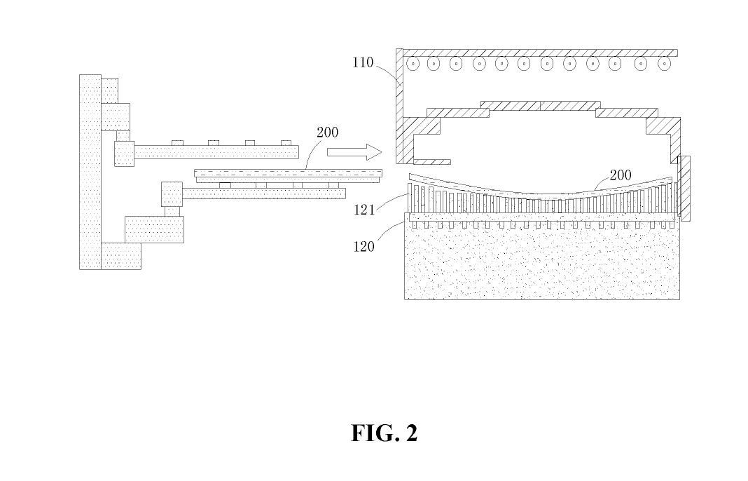

Referring to FIG. 1 and FIG. 2, an embodiment provides an ultraviolet curing apparatus 100, including an ultraviolet irradiation apparatus 110 and a support platform 120. Among them, the ultraviolet irradiation apparatus 110 is configured to irradiate a liquid crystal display (LCD) panel 200, which is to form a flexible LCD panel, with ultraviolet rays, i.e., ultraviolet exposure. The LCD panel 200 has flexibility (i.e., non-rigid). The LCD panel may be a flexible LCD panel after all of the manufacture process has been completed. Therefore, the LCD panel 200 is a state of the flexible LCD panel in the manufacture process, and has not been bended and fixed. The ultraviolet irradiation apparatus 110 may include an ultraviolet lamp 111, an ultraviolet lamp shutter 112 and a reflection mirror 113.

The support platform 120 is used to support the LCD panel 200. In addition, the surface of the support platform 120, which is used to support the LCD panel 200, is a curved surface, and the curved surface accords with the shape of the LCD panel 200 after being manufactured. Therefore, the shape of the surface of the support platform 120 accords with the shape of the flexible LCD panel which is formed after the manufacture process is completed, hence the surface of the support platform 120 in the present disclosure is designed based on the shape of the end product. For example, the shape of the surface of the support platform 120 may be an arc, and the middle of the surface is concave relative to the edge of the surface. Among them, the arc surface refers to a curved surface of which the section image is an arc.

In the ultraviolet curing manufacture (UVM) process, referring to FIG. 2, the LCD panel 200 is in a plain state before being conveyed to the ultraviolet curing apparatus 100. When the LCD panel 200 is disposed on the support platform 120 of the ultraviolet curing apparatus, since the LCD panel 200 has flexibility, the LCD panel 200 follows the shape of the surface of the support platform 120 to form a curved surface, so that the shape of the LCD panel is same with shape of the end product. Here, when the LCD panel 200 is irradiated by the ultraviolet irradiation apparatus 110 for ultraviolet exposure, the alignment process may be performed by simulating the end product.

Therefore, the ultraviolet curing apparatus 100 provided by the embodiments of the present disclosure makes it possible for the LCD panel 200 to complete the alignment process in a shape closer to the shape of the surface of the end product, the parallax of the flexible LCD panel may be improved, so that the above mentioned ultraviolet curing apparatus 100 makes the UVM process more applicable to the manufacture of the flexible LCD panel.

In one of the embodiments, the shape of the surface may be adjusted. In other words, the surface of the support platform 120 may be adjusted in different curved shapes. Therefore, since the end products have different shapes, the shape of the surface may be adjusted accordingly based on the shape of the end products, so as to be adapted to the manufacture of different types of flexible LCD panels, such that the applied range of the ultraviolet curing apparatus 100 has been enriched.

In one of the embodiments, referring to FIG. 1 and FIG. 2, the support platform 120 is provided with a plurality of supporting units 121, and the shape formed by the top of all the supporting units 121 is curved. Among them, the surface of the support platform 120 is formed by the top of all the supporting units 121.

Therefore, the top of each supporting unit 121 is used to support the LCD panel 200, and all of the supporting units 121 may use their differences in height to form the curved surface. For example, the supporting units 121 in edge area are highest, and the height of the supporting units 121 decreases towards the center. Furthermore, the height of the supporting units 121 from the edge area to the center decreases smoothly according to a certain radian. In addition, the supporting units 121 may be evenly distributed, so that each LCD panel 200 may support a force evenly.

Optionally, the height of each supporting unit 121 may be adjusted. When the height of the supporting unit 121 changes, the shape formed by the top of all the supporting units 121 may change accordingly. Therefore, if the shape of the curved LCD panel which is to be formed is different, the shape formed by the top of all the supporting units 121 may be changed by adjusting the height of the supporting units 121. For example, if the radius corresponding to the end product is relatively small, the height of the supporting units 121 closing to the center may be decreased.

The height of all the supporting units 121 may be unifiedly automatically controlled by a controller (e.g. a programmable logic controller). For example, all the supporting units 121 may be arranged on a same height adjusting apparatus. The height adjusting apparatus may include an actuating unit (e.g. a motor) and a mechanical structure, which drives the supporting unit 121 to move up and down or stretch out and draw back. Therefore, the controller may control the mechanical structure to drive the supporting unit 121 to move up and down by using the actuating unit, so that the height of all the supporting units 121 may be unifiedly adjusted.

The supporting unit 121 includes a die thimble. Among them, the die thimble is a plastic mold accessory, which is arranged in a plastic mold. The die thimble may be also called pushrod, pin, etc. It should be understood, the supporting unit 121 may be other types mechanical components which have the supporting function.

In addition, the supporting unit 121 may further include a preset quantity of lift pins. The lift pins are used to lift the LCD panel 200 to a certain height after the exposure of the LCD panel 200 is completed, so as to facilitate the mechanical arm to convey the LCD panel 200 to the next working station.

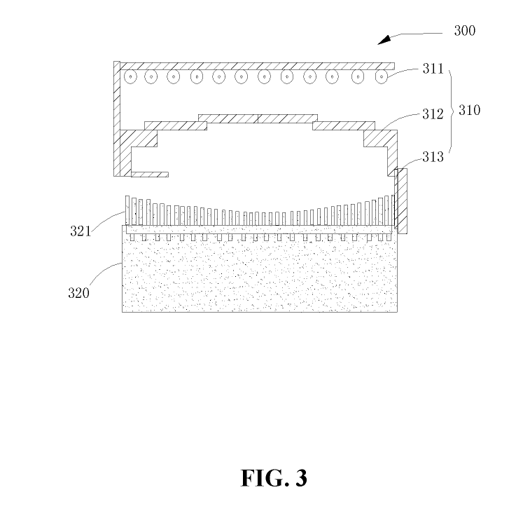

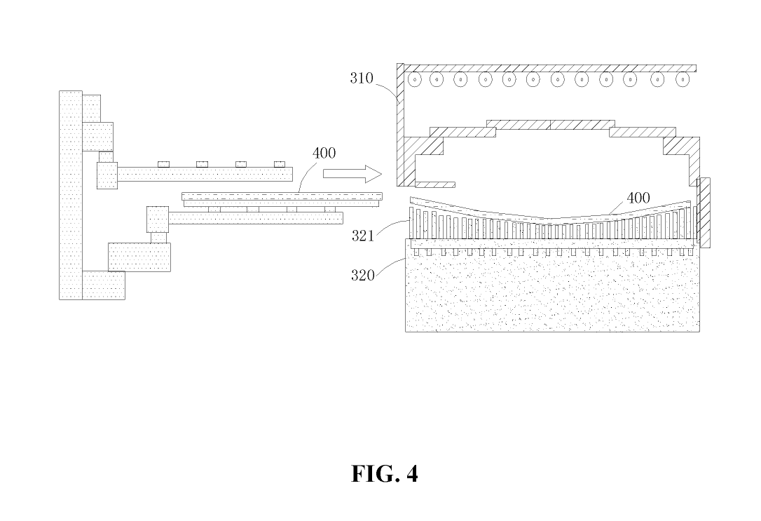

Another embodiment provides a support platform 320, referring to FIG. 3 and FIG. 4. The support platform 320 is arranged in the ultraviolet curing apparatus 300, and the support platform 320 is used to support the LCD panel 400 which is to form a flexible LCD panel, so that the LCD panel 400 is irradiated with ultraviolet rays.

Among them, the ultraviolet curing apparatus 300 includes the ultraviolet irradiation apparatus 310 and the support platform 320. The ultraviolet irradiating apparatus 310 is configured to irradiate the LCD panel 400 which is to form a flexible LCD panel with ultraviolet rays, i.e., the ultraviolet exposure. The LCD panel 400 has flexibility (i.e., non-rigid). The LCD panel may be a flexible LCD panel after all of the manufacture processes have been completed. Therefore, the LCD panel 400 is a state in the manufacture process of the flexible LCD panel, and has not been bended and fixed. Specifically, the ultraviolet irradiation apparatus 310 includes an ultraviolet lamp 311, an ultraviolet lamp shutter 312 and a reflection mirror 313.

In embodiments of the present disclosure, the shape of the surface of the support platform 320 used for supporting the LCD panel 400 is curved, and the shape of the curved surface is same with the shape of the LCD panel 400 of which the manufacture process is completed. Therefore, the shape of the surface of the support platform 320 is same with the shape of the flexible LCD panel which is formed after the manufacture process is completed. Hence the surface of the support platform 320 in embodiments of the present disclosure is designed based on the shape of the end product. For example, the shape of the surface of the support platform 320 may be an arc, and the center of the surface is concave relative to the edge of the surface. Among them, the arc surface refers to the curved surface of which the section image is an arc.

In the UVM process, referring to FIG. 4, the LCD panel 400 forms a plain state before being conveyed to the ultraviolet curing apparatus 300. After the LCD panel 400 is conveyed to the ultraviolet curing apparatus 300, since the LCD panel 400 has flexibility, the LCD panel 400 follows the surface of the support platform 320 to form a curved surface after the LCD panel 400 is disposed on the support platform 320, so that the shape of the LCD panel is same with shape of the end product. Here, when the LCD panel 400 is irradiated by the ultraviolet irradiation apparatus 310 for ultraviolet exposure, the alignment process may be performed by simulating the end product.

Therefore, the ultraviolet curing apparatus 320 provided by the embodiments of the present disclosure makes it possible for the LCD panel 400 to complete the alignment process in a shape closer to the shape of the surface of the end product, the parallax of the flexible LCD panel may be improved, so that the above mentioned ultraviolet curing apparatus 320 makes the UVM process more applicable to the manufacture of the flexible LCD panel.

In one of the embodiments, the shape of the surface may be adjusted. In other words, the surface of the support platform 320 may be adjusted in different curved shapes. Therefore, since the end products have different shapes, the shape of the surface may be adjusted accordingly based on the shape of the end products, so as to be adapted to the manufacture of different types of flexible LCD panels, such that the applied range of the ultraviolet curing apparatus 300 has been enriched.

In one of the embodiments, please refer to FIG. 3 and FIG. 4, the support platform 320 is provided with a plurality of supporting units 321, and the shape formed by the top of all the supporting units 321 is curved. Among them, the surface of the support platform 320 is formed by the top of all the supporting units 321.

Therefore, the top of each supporting unit 321 is used to support the LCD panel 400, and all of the supporting units 321 may use their differences in height to form the curved surface. For example, the supporting units 321 in edge area are highest, and the height of the supporting units 321 decreases towards the center. Furthermore, the height of the supporting units 321 from the edge area to the center decreases smoothly according to a certain radian. In addition, the supporting units 321 may be evenly distributed, so that each LCD panel 321 may support a force evenly.

Optionally, the height of each supporting unit 321 may be adjusted. When the height of the supporting unit 321 changes, the shape formed by the top of all the supporting units 321 may change accordingly. Therefore, if the shape of the curved LCD panel which is to be formed is different, the shape formed by the top parts of all the supporting units 321 may be changed by adjusting the height of the supporting units 321. For example, if the radius corresponding to the end product is relatively small, the height of the supporting units 321 closing to the center may be decreased.

The height of all the supporting units 321 may be unifiedly automatically controlled by a controller (e.g. a programmable logic controller). For example, all the supporting units 321 may be arranged on a same height adjusting apparatus. The height adjusting apparatus may include an actuating unit (e.g. a motor) and a mechanical structure, which drives the supporting unit 321 to stretch out and draw back. Therefore, the controller may control the mechanical structure to drive the supporting unit 321 to move up and down by using the actuating unit, so that the height of all the supporting units 321 may be unifiedly adjusted, thereby the shape of the surface of the loading platform 320 accords with the shape of the end products.

The supporting unit 321 includes a die thimble. The die thimble is a plastic mold accessory, which is arranged in a plastic mold. The die thimble may be also called pushrod, pin, etc. It should be understood, the supporting unit 321 may be other types mechanical components which have the supporting function.

In addition, the supporting unit 321 may further include a preset quantity of lift pins. The lift pins are used to lift the LCD panel 400 to a certain height after the exposure of the LCD panel 400 is completed, so as to facilitate the mechanical arm to convey the LCD panel 400 to the next working station.

The present disclosure further provides an ultraviolet curing apparatus, including: a support platform and a light source.

The support platform has an adjustable supporting surface which is used to support the flexible LCD panel. The light source is configured to irradiate the flexible LCD panel supported by the supporting surface of the support platform. The flexible LCD panel is used to form a curved LCD panel.

The support platform includes a plurality of supporting rods which are vertically disposed. The supporting rods may move vertically. The adjustable supporting surface is formed by the top of the supporting rods.

Optionally, the supporting rods are arranged in array.

Optionally, the light source is configured to provide ultraviolet rays which are used to irradiate the flexible LCD panel supported by the supporting surface of the support platform,

Optionally, the supporting rods may include a die thimble.

Optionally, the light source comprises an ultraviolet lamp, an ultraviolet lamp shutter and a reflection mirror.

Optionally, the supporting rods may include a lift rod.

All technical features in above embodiments may be arbitrarily combined, in order to achieve a simple description, all the possible combinations between all the technical features in above embodiments are not described entirely, and if combinations between all technical features have non-contradiction, it should be considered to fall into the scope the descriptions.

The above embodiments only present several embodiments of the present discloser, and although the descriptions are specific and detailed, it should not be considered as the limitations to the scope of the protection for the present disclosure. It should be noted, for those skilled in the art, various transformations and improvements may be made therein without departing from the inventive concept, and these may fall into the scope of protection for the present disclosure. Therefore, the scope of protection for the present disclosure is defined by the appended claims.

What is claimed is:

1. An ultraviolet curing apparatus, comprising:
a support platform configured to support a flexible liquid crystal display (LCD) panel; and
an ultraviolet irradiation apparatus configured to irradiate the flexible LCD panel with ultraviolet rays, wherein a surface of the support platform used for supporting the flexible LCD panel is a curved surface.

2. The ultraviolet curing apparatus according to claim 1, wherein a shape of the surface of the support platform used for support the flexible LCD panel is adjustable.

3. The ultraviolet curing apparatus according to claim 1, wherein the support platform is provided with a plurality of supporting units, and the surface used for supporting the flexible LCD panel is formed by top of all the supporting units.

4. The ultraviolet curing apparatus according to claim 3, wherein each supporting unit is configured to move up and down.

5. The ultraviolet curing apparatus according to claim 3, wherein each of the plurality of supporting units comprises a die thimble.

6. The ultraviolet curing apparatus according to claim 1, wherein the ultraviolet irradiation apparatus comprises an ultraviolet lamp, an ultraviolet lamp shutter and a reflection mirror.

7. The ultraviolet curing apparatus according to claim 3, wherein the support platform comprises an actuating unit, which is configured to enable the plurality of supporting units to move up and down.

8. A support platform, applied in an ultraviolet curing apparatus, wherein the support platform is configured to support a flexible liquid crystal display (LCD) panel, wherein a surface of the support platform used for supporting the flexible LCD panel is a curved surface.

9. The support platform according to claim 8, wherein a shape of the surface of the support platform used for supporting the flexible LCD panel is adjustable.

10. The support platform according to claim 8, wherein the support platform is provided with a plurality of supporting units, and the surface used for supporting the flexible LCD panel is formed by top of all the supporting units.

11. The support platform according to claim 10, wherein each supporting unit is configured to move up and down.

12. The support platform according to claim 10, wherein each of the plurality of supporting units comprises a die thimble.

13. The support platform according to claim 8, wherein the ultraviolet irradiation apparatus comprises an ultraviolet lamp, an ultraviolet lamp shutter and a reflection mirror.

14. The support platform according to claim 10, wherein the support platform comprises an actuating unit, which is configured to enable the plurality of supporting units to move up and down.

15. An ultraviolet curing apparatus, comprising:
a support platform having an adjustable surface which is used for supporting a flexible liquid crystal display (LCD) panel; and
a light source configured to irradiate the flexible LCD panel supported by the supporting surface of the support platform,
wherein the support platform comprises a plurality of supporting rods which are vertically disposed, the plurality of supporting rods are vertically movable, the adjustable supporting surface is formed by top of the plurality of supporting rods.

16. The ultraviolet curing apparatus according to claim 15, wherein the plurality of supporting rods are arranged in array.

17. The ultraviolet curing apparatus according to claim 15, wherein the light source is configured to provide ultraviolet rays which are used to irradiate the flexible LCD panel supported by the supporting surface of the support platform,

18. The ultraviolet curing apparatus according to claim 15, wherein the plurality of supporting rods comprises a die thimble.

19. The ultraviolet curing apparatus according to claim 17, wherein the light source comprises an ultraviolet lamp, an ultraviolet lamp shutter and a reflection mirror.

20. The ultraviolet curing apparatus according to claim 15, wherein the plurality of the supporting rods comprises a lift pin.
